(19) United States
(12) Patent Application Publication
(10) Pub. No.: US 2018/0024555 A1
(43) Pub. Date: Jan. 25, 2018

(54) UAV NAVIGATION AND SENSOR SYSTEM CONFIGURATION

(71) Applicant: ROCKY MOUNTAIN EQUIPMENT CANADA LTD., Calgary (CA)

(72) Inventors: Curtis PARKS, Ottawa (CA); Chris POLOWICK, Ottawa (CA)

(21) Appl. No.: 15/547,208

(22) PCT Filed: Jan. 29, 2016
(86) PCT No.: PCT/CA2016/050078

§ 371 Date: Jul. 28, 2017

Related U.S. Application Data
(60) Provisional application No. 62/109,352, filed on Jan. 29, 2015.

(51) Int. Cl. G05D 1/00; B64C 39/02

(52) U.S. Cl. CPC G05D 1/0088; B64C 39/024; B64C 2201/141; B64C 2201/127; G01S 19/43

(57) ABSTRACT

Systems, methods and devices for use with unmanned aerial vehicles (UAV). A central controller is coupled to the autopilot system for a UAV. Navigation is implemented by using two GPS antennas and obtaining a difference between the locations from these two antenna to arrive at a high precision bearing or direction of travel. This single GPS derived bearing is used to trigger all the various subsystems on the UAV for imaging or mapping. Areas and locations to be mapped and imaged are determined by geolocation and mapping and imaging equipment are triggered based on the single GPS signal derived from the two GPS antennas. To reduce vibration effects on navigational and imaging or mapping equipment, these are positioned as close as possible to the vehicle's center of gravity and are deployed in a shielded box on vibration isolation mounts.

### TECHNICAL FIELD

The present invention relates to unmanned aerial vehicles (UAVs). More specifically, the present invention relates to methods, systems, and devices for navigating and configuring a UAV.

### BACKGROUND

The rise in the use of UAV has led to a myriad of uses for this technology. Its military applications are infamous and well-known while its more mundane applications continuously increase in number. One use for such vehicles is that of surveying and mapping large swathes of land. Unfortunately, current UAVs are not as useful as desired.

Current UAV technologies suffer from needing complex schemes to properly image and map geographic areas. Current methods require large areas to be imaged and mapped even when only a small subset of that area needs to be mapped or imaged. As well, current UAV technologies suffer from lack of pinpoint control when it comes to navigating areas far from the base station.

Another issue with current UAV technologies is their susceptibility to vibrations and unwanted oscillations caused by the UAV engines. Such vibrations and oscillations have been known to degrade the effectiveness of navigation instrumentation, imaging equipment and other sensitive equipment required for mapping and imaging areas from the sky.

It is therefore an object of the present invention to mitigate if not overcome the shortcomings of the prior art and to thereby provide systems and methods that render UAVs more suitable for large-scale mapping and imaging missions.

### SUMMARY

The present invention provides systems, methods and devices for use with unmanned aerial vehicles (UAV). A central controller is coupled to the autopilot system for a UAV. Navigation is implemented by using two GPS antennas and obtaining a difference between the locations from these two antennas to arrive at a high precision bearing or direction of travel. This single GPS derived bearing is used to trigger all the various subsystems on the UAV for imaging or mapping. Areas and locations to be mapped and imaged are determined by geolocation and mapping and imaging equipment are triggered based on the single GPS signal derived from the two GPS antennas. To reduce vibration effects on navigational and imaging or mapping equipment, these are positioned as close as possible to the vehicle's center of gravity and are deployed in a shielded box on vibration isolation mounts.

In a first aspect, the present invention provides a system for use in an unmanned aerial vehicle (UAV), the system comprising:
a primary GPS antenna;
a secondary GPS antenna;
a controller for receiving GPS readings from said primary and secondary GPS antennas and for producing a single GPS signal based on readings from the GPS readings;
   wherein
said primary GPS antenna is spaced apart from said secondary GPS antenna;
said system determines a heading of said UAV by determining a difference between GPS readings from said primary GPS antenna and GPS readings from said secondary GPS antenna;
said single GPS signal is used to control at least one other subsystem on said UAV.

In a second aspect, the present invention provides a structural panel comprising:
a first layer of carbon fiber skin;
a second layer of carbon fiber skin;
a core material sandwiched between said first layer and said second layer;
a rigid insert sandwiched between said first layer and said second layer and surrounded by said core material;
   wherein
said first layer, said second layer, and said core material are infused with a resin.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of an environment in which the present invention may be used;

FIG. 2 is a block diagram of the various subsystems of a UAV according to one aspect of the invention;

FIG. 3 is a block diagram illustrating the data connections between the various subsystems on the UAV;

FIG. 4 is an illustration of a side cut-away view of a strong, rigid, yet lightweight panel constructed using techniques according to another aspect of the invention; and

FIGS. 5 and 6 are illustrations of a UAV constructed and arranged according to the various aspects of the invention.

### DETAILED DESCRIPTION

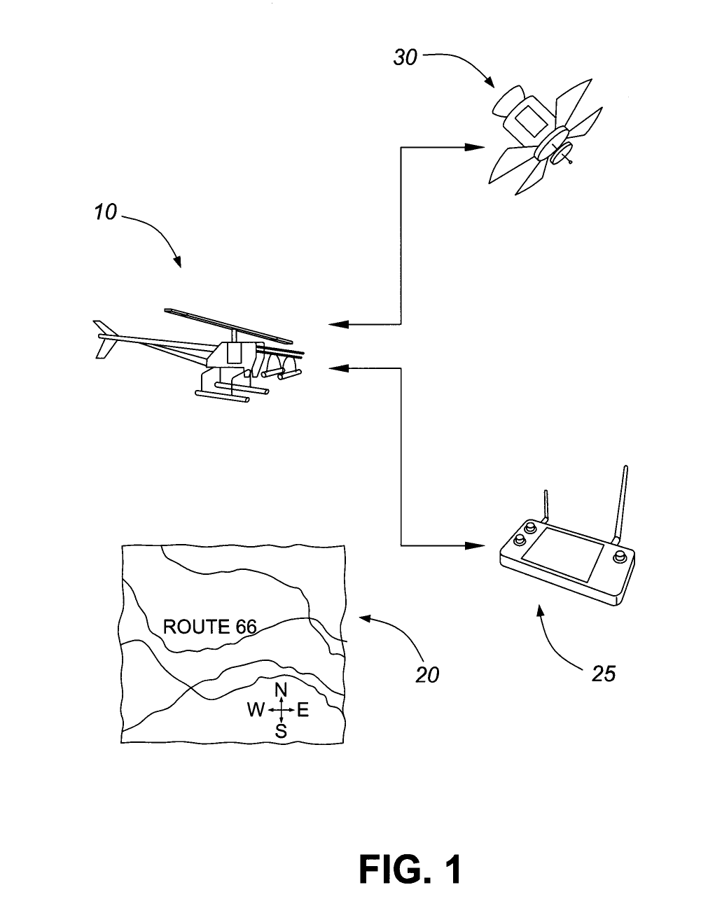

Referring to FIG. 1, a block diagram of the environment in which the present invention may be used is illustrated. As can be seen, a UAV 10 is used for mapping and/or imaging a specific area 20. The UAV 10 is in communications with and is controlled by a base station 25. The UAV 10 receives data from a satellite 30 to determine its position.

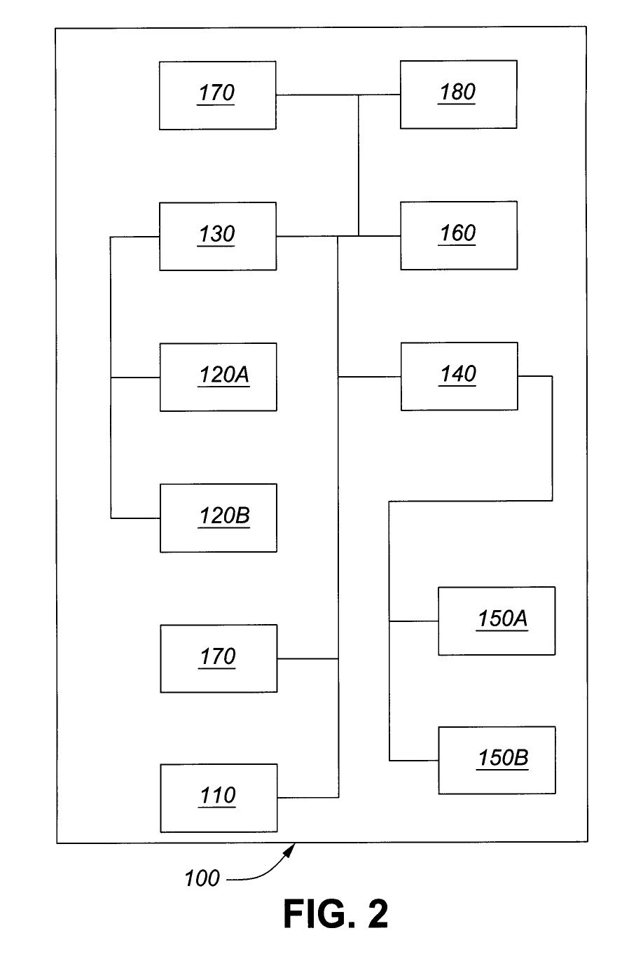

Referring to FIG. 2, a block diagram of the various subsystems of a UAV is illustrated. The system 100 includes a LiDAR subsystem 110, a multispectral digital camera 120A, a DSLR digital camera 120B, a camera controller 130, a GPS subsystem 140, two GPS antennas 150A, 150B, an autopilot subsystem 160, an inertial measurement unit (IMU) 170, and a controller 180. The controller 180 may be a payload controller and it may be configured to cooperate with the various payloads and their dedicated controllers.

It should be noted that the GPS subsystem, using data from the two GPS antenna, produces a single GPS signal that is used by all the other subsystems for their timing, triggering, and location. To improve the integration of the various subsystems, the UAV, in one implementation, is equipped with an on-board network through which at least some of the subsystems communicate.

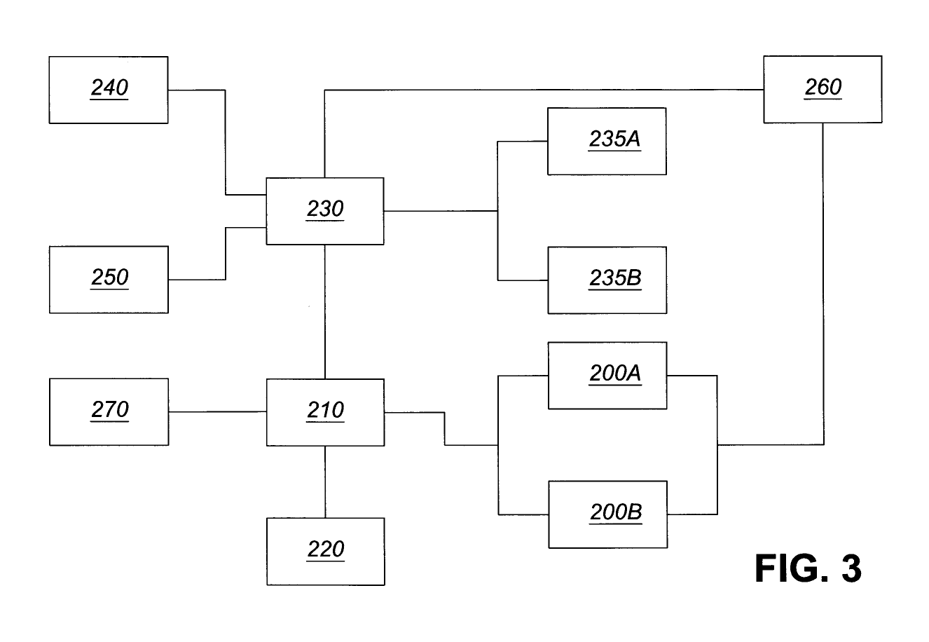

Referring to FIG. 3, a block diagram of such a data network on a UAV is illustrated. Two communications system modules (an RF communications module 200A and a satellite communications module 200B) are coupled to a network switch 210. The network switch 210 also couples a LiDAR module 220 and a GPS interface 230. The GPS interface interfaces with the two GPS antennas (GPS antennas 235A and 235B in FIG. 3) and produces a single GPS timing signal which is used by all the other subsystems on-board the UAV, including the sensor subsystems (e.g. the LiDAR module). By way of the GPS interface, a camera module 240 is coupled to or at least addressable by the various subsystems of the UAV. Also coupled to the GPS interface to receive the single GPS signal is an inertial measurement unit (IMU) module 250 and an autopilot module 260. The autopilot module 260 can receive commands from either of the communications modules 200A, 200B. The GPS interface's single GPS signal can be used to trigger the camera module 240 or the LiDAR module 220. Other payload and/or sensors 270 can also be coupled to the switch 210.

It should be noted that the single GPS signal used by the various modules can take the form of an extremely accurate timing pulse that gets sent once per second (a PPS signal). In one implementation, a serial communication interface is used by the various modules to communicate with the GPS interface. This serial interface allows any of the modules to communicate with the GPS interface and request different types of data. The serial communication interface allows the modules to request whatever data they require (e.g. UAV position, heading, IMU data, etc.).

The timing pulse can be a logic-high pulse that occurs once per second and this can be measured by whichever module is receiving it. The serial communication interface may use a serial communications Tx/Rx pair. This serial communications interface may be configured to use the RS-232 protocol (or, indeed, any serial communications protocol) to transmit data to and receive data from the GPS interface. Data is read from the GPS interface by requesting a log over the serial port. The log can be a single instance, a repeating log at a specified frequency (such as the 200 Hz IMU signal), or a log synchronized with an external input (such as the camera trigger). When the log is requested (using a suitable command structure), the response bytes are sent out over the serial port to whatever hardware is receiving the logs, and can be interpreted using the appropriate message structure. Each different component or module that is interfacing with the GPS interface board can connect on a different serial port, and request its own unique logs.

The network illustrated in FIG. 3 can be implemented as a local area network (LAN) on board the UAV. In one implementation, an Ethernet network connects the LiDAR module 220 with the GPS interface 230 and the communications modules 200A, 200B. This allows a user to query whether the payloads (e.g. the camera, the LiDAR, and the other payloads/sensors) are operating even when the UAV is airborne. Such queries would not require a lot of bandwidth and, as such, this can be implemented even if the RF communications module only allows for a low bandwidth data connection to the base station.

In one implementation, the IMU module is coupled to the GPS interface. Data from the IMU module is sent to and is processed by the GPS interface. The resulting data is then distributed to the other sensor modules by way of the GPS interface. Depending on the configuration of the UAV, this may be done by way of the data network described above.

It should be noted that, in one implementation, the system 100 does not include a compass. The directional heading is calculated from the difference between the readings obtained from the two GPS antennas. The two GPS antennas are located at different ends of the UAV, preferably one at the tail of the UAV and another at the head of the UAV. In one implementation, the distance between the two antennas is approximately 6 feet. The GPS subsystem takes a geolocation reading from one antenna and then takes another geolocation reading from the other antenna. Using these two spatial coordinates, a vector can then be calculated and this vector operates as the heading or bearing of the UAV. This use of differential GPS readings allows the UAV to avoid using a magnetic compass which would be subject to analog errors as well as errors due to magnetic disturbances and perturbations.

It should be noted that the use of two GPS antennas allows for the use of differential GPS and can provide not only an accurate GPS location of the UAV but also an accurate heading. In such a system, one GPS antenna is used as a master antenna and the UAV's location is determined from readings from this antenna. The other GPS antenna is used to calculate, in conjunction with readings from the master GPS antenna, the UAV's heading. While the above describes a separation of 6 feet between the two GPS antennas, a larger distance between these antennas would provide for a more accurate heading as heading accuracy is proportional to the separation distance between the two antennas. As well, it should be noted that while the above describes one antenna at the front of the UAV and another at the rear of the UAV, the two antennas may be placed at any location on the UAV, taking into account that heading accuracy is affected by the separation distance between the antennas. In the event the antennas are not positioned at the front and rear of the UAV, heading calculations may require an angular offset to compensate for the angle between the line delineated by the two antennas and the UAV's longitudinal axis.

The use of a heading from the two GPS antennas provides a highly accurate reading of the UAV's position and direction. As noted above, this reading provides for a single GPS signal that is received and used by the autopilot subsystem, the camera controller, and the LiDAR subsystem. This heading calculation may be performed by the GPS interface or, for a simpler implementation, by a DGPS module designed specifically to determine heading from differential GPS readings.

The system uses the controller 180 to control the various subsystems and to ensure that the proper navigational data (e.g. the single GPS reading or signal) is received by these various subsystems. Navigational and positional data is used by most of the subsystems to obtain accurate images and plots of the ground targets. As an example, each image taken by the various cameras (e.g. the multispectral camera and the DSLR digital camera) is automatically geo-referenced using data from the IMU, the heading obtained from the differential GPS readings, and the GPS readings. In one implementation, every image is synchronized with IMU data with a 4 ms accuracy. This ensures that attitude and location data is used with lens distortion to accurately map every pixel in an image to a GPS location. To accomplish this high accuracy mapping of images to location, the IMU is preferably rigidly mounted to an aluminum frame that attaches to the two camera systems. This allows the IMU to control the two cameras independently. In one implementation, the IMU can be used to control the various cameras as well as the LiDAR.

To ensure that only the required areas are imaged, the cameras are controlled by input from the GPS and the autopilot subsystems. The cameras are controlled such that images are taken or captured only when the UAV's flight transects over the survey area and not during takeoff, landing, or flying between transects. The relevant cameras can be triggered by the controller based on the distance flown by the UAV or by the time of the UAV's flight. This prevents a large number of unnecessary pictures from being captured when the UAV is hovering or accelerating from a hover. This is accomplished by the autopilot sending relevant signals to the controller when the UAV is flying down a pass over the target area. When the UAV is in lift-off or landing mode or when the UAV is between passes over the target area, the autopilot does not send these signals. Only when the autopilot sends these signals does the controller activate the cameras to image the target area.

To address the potential issue of vibrations and their effects on the UAV's instrumentation, all the flight electronics have been rigidly mounted to a shielded electronics box. This electronics box is mounted on vibration isolation (or soft isolation) mounts. This configuration would effectively isolate the electronics from the various vibrations to which the UAV is subject to. In one implementation, the electronics box is located above the UAV and is located as close to the UAV's center of gravity as possible.

To minimize the effects of a shifting center of gravity, the LiDAR sensor is fixed close to the center of gravity of the UAV. The box and the LiDAR sensor is placed close enough to the UAV frame such that the rotational motion of the UAV does not give rise to significant swaying or translational motion of the LiDAR sensor and of the other sensors in the electronics box. To accomplish this, it is preferred that the cabling attaching the electronics box and its contents to the rest of the UAV be left loose and free-hanging. As can be imagined, the cabling should also be mounted and secured to prevent fraying or rubbing with the other parts of the UAV. Preferably, the sensor and the box be as high as possible on the UAV but also be as close as possible to the UAV's center of gravity.

The electronics box and the LiDAR sensor can be supported by vibration isolation mounts to the UAV frame. In one implementation, these two are mounted together so that the added weight of the LiDAR sensor heightens the effectiveness of the vibration isolation mounts such that they more effectively dampen low frequency vibrations caused by the UAV's motors and rotors. Of course, in other implementations, the electronics box and the LiDAR sensor are not mounted together.

As a further measure to assist in the load balancing for the UAV, the camera sensors are preferably mounted at the front of the UAV. This allows the secondary GPS antenna to be mounted as far as possible from the primary GPS antenna. For a rotary UAV, this also prevents the rotor hub from shielding the front GPS antenna.

The UAV system of the invention is capable of performing accurate surveys over large areas because all flight control functions are handled by an on-board autopilot processor (i.e. the controller). This autopilot relies on accurate and reliable IMU, compass, and GPS data to stabilize and control the helicopter during flight. To assist in this, the electronics are shielded from the large amount of vibrations and electromagnetic interference produced by the UAV. As well, these vibrations and interference are compensated for. These accurate IMU readings, headings, and GPS systems are also synchronized to camera trigger events, thereby providing camera imagery which are geo-located without the need for time-consuming ground target placement and measurement.

The autonomous UAV system seamlessly integrates data from a number of different sources and uses an on-board processer to deliver this data to the sensors and to the autopilot subsystem. Care was taken to avoid redundant sensors, and to allow a small number of sensors to gather data for the autopilot and all the various cameras. This reduces weight, cost and complexity. High-accuracy sensors were used that, in addition to improving autopilot performance, can be used to geo-locate imagery. The effects of rotor and engine vibrations and electrical noise on the sensors were mitigated by carefully locating the electronics and by using to advantage a number of vibration isolation mounts and the weight of the LiDAR sensor. A differential GPS compass system was integrated into the autopilot and sensor control system to avoid issues of electromagnetic interference.

Regarding the software operating on the controller, the software continuously monitors the GPS readings in conjunction with the readings from the autopilot. When the GPS reading indicates that the UAV's location is within a certain distance of the target area, the controller activates one or both of the camera subsystems. With each image frame, the controller stamps the image with the relevant GPS coordinates to mark the location of the UAV when the image frame was captured. This ensures that each frame is marked with a location.

To assist in the operation of the UAV, a number of manufacturing techniques have been developed to arrive at materials which are both lightweight and strong. These manufacturing techniques also allow for connection points that are suitable for use with bolts and other attachment mechanisms.

For at least some of the UAV panels, a composite material made from a strong, rigid fabric embedded in a polymer matrix is used. Reinforcement of the composite material may be used to support the structural loads on the UAV. The polymer matrix is used to transfer shear stress between reinforcement fibers.

In most composite manufacturing processes, a fibrous material is infused with a matrix material and cured. In the method used with the panels for the UAV, a woven composite matrix is infused with a liquid 2-part epoxy. The material is compacted under vacuum pressure to remove as much unnecessary resin as possible and allowed to cure. When the polymer has cured, the resulting material is extremely rigid and lightweight.

For at least some of the panels, a lightweight, rigid material is embedded between layers of composite during manufacturing to improve the stiffness of the material. This is referred to as a sandwich structure. It should be noted that while carbon fiber sandwich structures produce lightweight and stiff panels, such panels have poor point load bearing characteristics (such as from a bolt or rivet) when compared to aluminum parts. Because the design of some UAVs require bolts to fasten components, current carbon fiber sandwich structures may not be suitable for some UAV applications.

In one variant of such carbon fiber sandwich structures, an aluminum mesh is embedded under a layer of carbon. While, this does not serve a structural purpose, it is used to make the carbon highly electrically conductive for components such as antenna grounding planes.

To address the load bearing characteristics of carbon fiber sandwich structures, aluminum inserts may be used at the load bearing points of the panels.

The panels are constructed using a carbon fiber reinforced polymer skin, a room temperature cure, 2-part epoxy resin, and, for the sandwiched material, a meta-aramid core material formed into a honeycombed structure. One meta-aramid core material may be found marketed under the tradename NOMEX™. Where necessary, solid aluminum inserts may be used as support for bolts at connection or mounting points on the resulting panels. To form the panel into specific desired shapes, a mould may be used. Preferably, the mould is made from glass to ensure that the resulting panel has a smooth and flat surface.

To manufacture the lightweight and strong panels, the following steps below may be used. It should be noted the steps assume that aluminum inserts are necessary. These steps are as follows:

1) Using a water jet, cut out aluminum template(s);

2) Using a water jet, cut aluminum inserts;

3) Using the aluminum template, cut carbon fiber skin and core material to size;

4) Based on the aluminum template, cut holes in the core material for the aluminum inserts;

5) Using a non-reactive polytetrafluoroethylene (PTFE marketed as Teflon™) tape, mark datum lines along 2 edges of the core material;

6) Temporarily adhere all carbon fiber skin layers for the first side of the panel together using spray tack;

7) Cut carbon fiber skin on the first side of the panel back from 2 datum edges to expose strips of PTFE tape;

8) Infuse the first side of the carbon fiber skin and the core material with the resin (see below);

9) Infuse the second side of the carbon fiber skin with resin (see below);

10) Using a water jet, cut the outline of the components from the resulting sandwich structure panel.

To infuse the panel's first side of carbon fiber skin and core material with resin, the following steps may be followed:

a) Prepare mould surface. This may be done by stripping the surface of any oils, dirt, or other contaminants using a specialized cleaner. A mould release wax is then applied to the mould surface. The mould surface is then polished with a cloth. This will prevent the resin from bonding to the glass of the mould. The outline of the carbon fiber skin layup is then marked on the glass surface, preferably with a dry erase marker.

b) Mix the resin in the appropriate ratios. Place the mixed pot of resin in a vacuum chamber and draw as deep a vacuum as possible (˜29.5 inHg). Leave the resin in the vacuum chamber for 10 minutes. This draws out air pockets trapped within the resin that will lead to voids in the final material.

c) Remove resin from vacuum chamber, pour the resin on the glass. Spread the resin so that the resin evenly covers the surface area marked in the previous step (step a).

d) Place the carbon fiber skin fabric on the resin. With a spreader, work the carbon fiber skin fabric into the resin underneath until the whole carbon fiber cloth fabric is saturated completely.

e) If embedded aluminum mesh is required, place the aluminum mesh on the carbon fiber skin at this stage.

f) Lay the core material on top of the carbon fiber skin, making sure not to distort the material during lay-up.

g) Place all aluminum inserts in the pre-cut holes. Place aluminum cutting template on top of the core material. At this stage it is critical to make sure that the datum edges marked with PTFE tape line up with the corresponding edges on the template, and that each individual insert lines up or is aligned with the opening on the cut template.

h) Remove the cutting template and place a layer of Peel Ply nylon mesh on top of the layup. Peel Ply nylon mesh is a “Release Fabric,” or a synthetic cloth that is draped epoxied surfaces as the epoxy sets. The nylon mesh fabric is a release film that prevents any resin from bonding to the top surface of the core material.

i) Place a layer of breather on top of the nylon mesh cloth to provide a path for air removal, and to absorb excess resin;

j) Cover the entire layup in a vacuum bag. Seal the bag against the mould surface using sealant tape, and attach a vacuum outlet to the bag.

k) Turn on vacuum pump and draw a deep vacuum (˜29.5 inHg) while making sure the bag is sealed and no leaks are present. When full vacuum is achieved and can be maintained without the use of the pump, drop the vacuum to 15-20 inHg, and cure the resin.

To infuse the panel's second side of carbon fiber skin with resin, the following steps may be taken:

a) Repeat steps a)-d) above with the carbon fiber skin of the second side of the panel.

b) Place the carbon fiber skin-core material produced in step 8 above face-down on the wetted carbon (the second side), making sure to line up the datum edges of the first side with the datum edges of the second side.

c) Repeat steps h)-k) above for this layup.

A number of points must be kept in mind when cutting the components from the sandwich structured panel. Specifically, it should be noted that water-jet cutting allows a cut pattern to be followed very accurately relative to a digitized cut path produced using CAD software. It is preferred that the cut paths are all referenced relative to the two datum edges. In this way, the zero of the machine is aligned manually with the datum edges before cutting. In doing so, the machine will place the cuts in the proper location relative to the inserts. The holes themselves are not cut as cutting through the aluminum with the water jet cutter will cause significant delamination, and may destroy the panel.

To assist in the drilling of holes through the aluminum inserts, 2 small holes are cut through each panel with as much separation as the part allows. These holes are not placed over an insert and are used for alignment with a drilling template. This drilling template is bolted to the panel using the two holes, and is used to match-drill through all inserts.

It should be noted that the above process uses metallic inserts in a carbon fiber-core material sandwich panel to support the mounting hardware such as bolts. The inserts can be aligned using the above steps. Some of the novel aspects of the above steps are the use of PTFE tape to mark a datum on the core material, the use of a cutting template to align insert holes with the core material datum, the use of a 2-part infusion process that allows inserts to be placed between the carbon fiber skin layers, and the use of drill alignment holes to ensure that the drill pattern is aligned with the outer cut profile as well as with the insert locations. It should be noted that the inserts may be any other type of rigid insert which can be used to support the load bearing sections of panel. As well, it should be noted that, preferably, the insert is inserted into the core and is bonded to the two carbon fiber skins.

It should also be noted that, if necessary, an aluminum mesh may be embedded in the panel to render the panel conductive. This allows the panel to be used as a grounding plane.

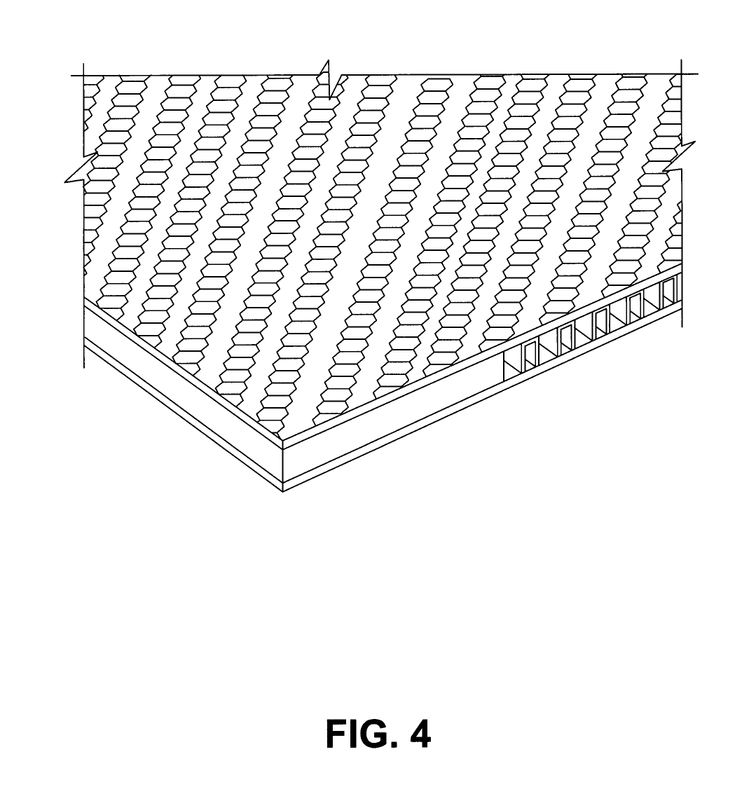

For ease of reference, a cut-away picture of the resulting panel, showing the insert and the honeycomb structure of the core material, is shown in FIG. 4.

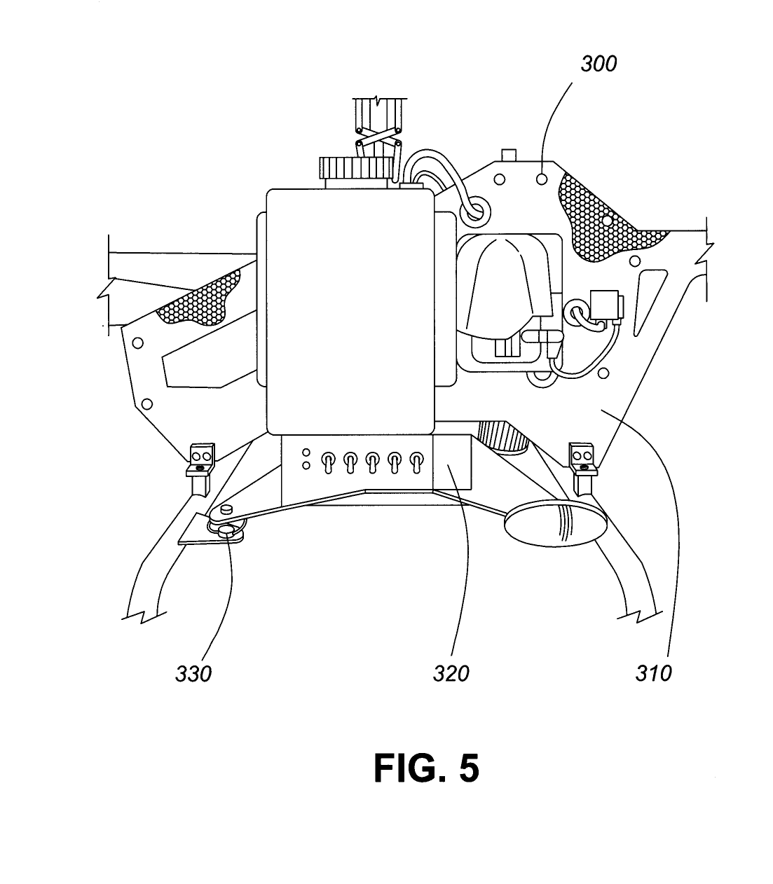

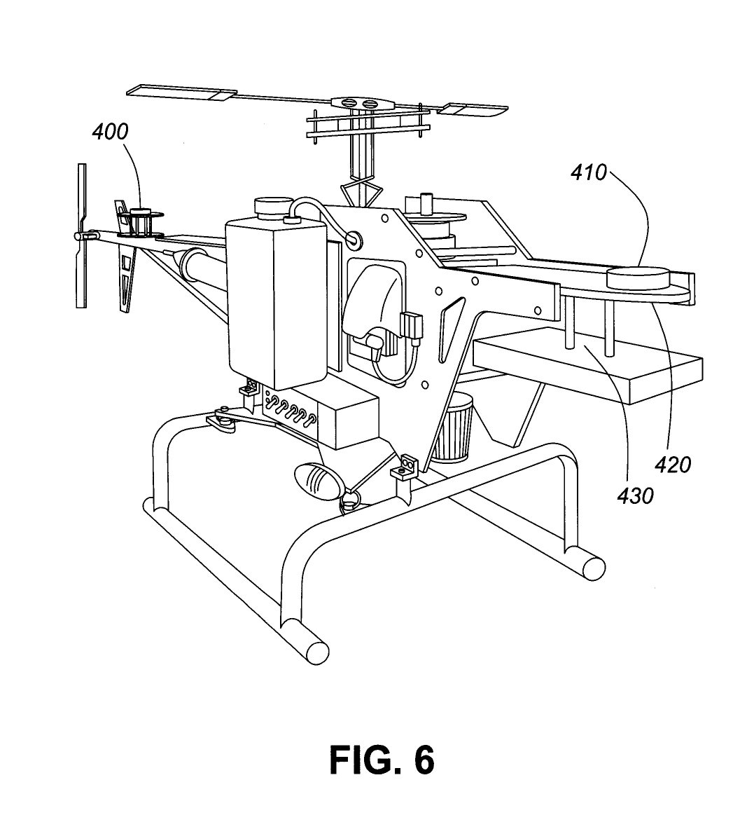

Referring to FIGS. 5 and 6, an image of a UAV according to some of the aspects of the invention is illustrated. In FIG. 5, reference 300 shows bolts fastened through a panel equipped with inserts as described above. Reference 310 shows side panels produced according to the above described process. In the UAV, reference 320 illustrates that the autopilot subsystem is mounted close to the UAV's center of gravity to minimize vibrations while reference 330 shows that sensitive electronics are mounted on vibration isolators to ensure proper functioning of the electronics.

In FIG. 6, the secondary GPS antenna is illustrated (reference 400) while the primary GPS antenna (reference 410) is also shown. As can be imagined, the secondary GPS antenna is used for GPS compass uses while the primary GPS antenna is used for positioning and GPS compass uses as well. Reference 420 shows a carbon fiber panel with an aluminum mesh and used as a grounding plane. Reference 430 shows a payload mounting location (with a simulated payload weight). As noted above, the payload is mounted as high as possible to improve helicopter dynamics.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g.“C”) or an object-oriented language (e.g.“C++”, “java”, “PHP”, “PYTHON” or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A system for use in an unmanned aerial vehicle (UAV), the system comprising:
a primary GPS antenna;
a secondary GPS antenna;
a controller for receiving GPS readings from said primary and secondary GPS antennas and for producing a single GPS signal based on readings from the GPS readings;
wherein
said primary GPS antenna is spaced apart from said secondary GPS antenna;
said system determines a heading of said UAV by determining a difference between GPS readings from said primary GPS antenna and GPS readings from said secondary GPS antenna;
said single GPS signal is used to control at least one other subsystem on said UAV.

2. A system according to claim 1, wherein said system further comprises a plurality of image capturing devices, said image capturing devices being controlled by said controller using said single GPS signal such that said controller activates said image capturing devices only when a location of said UAV is near a predetermined target area.

3. A system according to claim 1, wherein electronics on said UAV are enclosed in an electronics box located adjacent a center of gravity of said UAV.

4. A system according to claim 3, wherein said electronics box is mounted on vibration isolation mounts.

5. A system according to claim 1, wherein said system further comprises an autopilot subsystem, said autopilot subsystem using said single GPS signal such that said heading of said UAV is derived from said primary and said secondary GPS antennas to control a flight of said UAV.

6. A system according to claim 2, wherein every image captured by said plurality of image capturing devices is marked with a location indicating a location of an area portrayed in said image.

7. A system according to claim 1, wherein said single GPS signal synchronizes all other subsystems on said UAV.

8. A system according to claim 1, further including a data network for allowing said other subsystems to communicate with one another.

9. A system according to claim 8, wherein said data network comprises a data network switch to which said other subsystems are coupled to thereby allow said other subsystems to communicate with one another.

10. A system according to claim 8, wherein said data network is coupled to at least one communications module to thereby allow data from said communications module to control at least one of said other subsystems.

11. A system according to claim 1, wherein said UAV is equipped with at least one structural panel having a sandwich structure in which a core material is sandwiched between a first layer of carbon fiber skin and a second layer of carbon fiber skin, said core material and said first and second layers of carbon fiber skin being infused with a resin.

12. A system according to claim 11, wherein said at least one structural panel further comprises at least one rigid insert sandwiched between said first and said second layer of carbon fiber skin, said insert being for providing structural support for at least on load bearing mounting.

13. A system according to claim 12, wherein said insert is metal.

14. A structural panel comprising:
a first layer of carbon fiber skin;
a second layer of carbon fiber skin;
a core material sandwiched between said first layer and said second layer;
a rigid insert sandwiched between said first layer and said second layer and surrounded by said core material;
wherein
said first layer, said second layer, and said core material are infused with a resin.

15. A panel according to claim 14, wherein said panel is used on a UAV.

16. A panel according to claim 14, wherein said core material has a honeycomb structure.

17. A panel according to claim 14, wherein said core material is a meta-aramid material.

18. A panel according to claim 14, wherein said rigid insert is constructed of aluminum.

19. A panel according to claim 14, further comprising an aluminum mesh placed between said core material and at least one of said first layer or said second layer.
